(19) United States
(12) Patent Application Publication
(10) Pub. No.: US 2016/0019886 A1
(43) Pub. Date: Jan. 21, 2016

(54) METHOD AND APPARATUS FOR RECOGNIZING WHISPER

(71) Applicant: Samsung Electronics Co., Ltd., Suwon-si (KR)

(72) Inventor: Seok Jin HONG, Hwaseong-si (KR)

(73) Assignee: SAMSUNG ELECTRONICS CO., LTD., Suwon-si (KR)

(21) Appl. No.: 14/579,134

(22) Filed: Dec. 22, 2014

(30) Foreign Application Priority Data
Jul. 16, 2014 (KR) 10-2014-0089743

(51) Int. Cl. G10L 15/08; G06F 3/0488; G06F 3/041

(52) U.S. Cl. CPC G10L 15/08; G06F 3/0414; G06F 3/04883

(57) ABSTRACT

A method and an apparatus of recognizing whisper are provided. The method of recognizing a whisper may include recognizing a whispering action performed by a user through a first sensor, recognizing a loudness change through a second sensor, and activating a whisper recognition mode based on the whispering action and the loudness change.

### CROSS-REFERENCE TO RELATED APPLICATION

This application claims the benefit under 35 USC 119(a) of Korean Patent Application No. 10-2014-0089743 filed on Jul. 16, 2014, in the Korean Intellectual Property Office, the entire disclosure of which is incorporated herein by reference for all purposes.

### BACKGROUND

1. Field

The following description relates to a method of recognizing whisper and a user terminal that performs such a method, and to technology for accurately recognizing a voice command included in a whisper of a user by activating a whisper recognition mode in response to detecting a whisper through sensors. The whisper may be detected based on determining whether there is a loudness change in the sound detected through the sensors.

2. Description of Related Art

A voice interface refers to an input method by which a user's command may be received. A voice interface may provide a more natural and intuitive manner in which a command may be communicated in comparison to a touch interface in that people are used to communicate their desires by speaking rather than by registering a touch input via a touch input device. Thus, voice interface is gaining attention as a next-generation interface that may compensate for inconvenience of the touch interface.

However, speaking to a machine using a loud voice in a public place may be embarrassing to the general public or may be socially unacceptable under certain circumstances. Thus, there is a difficulty in using the voice interface in a public place or a quiet place. This issue is one of major shortcomings of voice interface that may be hindering the proliferation of the voice interface. Hence, the voice interface is mainly being used in an extremely limited number of locations in which a user alone is present, such as in a vehicle, for example. Accordingly, there is a desire to provide a method of using the voice interface without inconveniencing others in public places.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of recognizing a whisper is provided, the method involving recognizing a whispering action performed by a user through a first sensor, recognizing a loudness change through a second sensor, and activating a whisper recognition mode based on the whispering action and the loudness change.

The recognizing of the whispering action may be performed based on any one of whether a touch is detected on a screen of a user terminal through a touch sensor, whether a touch pressure exceeds a pressure threshold value, and whether a touch is input within a preset area on the screen of the user terminal.

The recognizing of the whispering action may be performed based on whether a change in a light intensity detected through a light intensity sensor exceeds a preset light intensity threshold value.

In response to the whisper recognition mode being activated, the activating further involves recognizing the whisper using a whisper recognition based voice model.

The whisper recognition based voice model may be configured to reflect a voice change associated with whispering and a voice reverberation associated with a hand gesture performed to whisper.

In another general aspect, a method of recognizing a whisper is provided, the method involving detecting a hand gesture performed to whisper and a voice input associated with the whisper, and determining whether to activate a whisper recognition mode based on the hand gesture and the input voice.

The determining may be performed by combining information on whether a touch is input on a screen of a user terminal by the hand gesture, a change in a light intensity generated based on the hand gesture, and a loudness change of the input voice.

The determining may be performed by combining information on whether a touch is input within a preset area on a screen of a user terminal by the hand gesture, information on whether a change in a light intensity generated based on the hand gesture exceeds a preset light intensity threshold value, and information on whether a loudness change of the input voice exceeds a preset loudness threshold value.

In response to the activating being determined, the determining further involve recognizing words contained in the whisper using a whisper recognition based voice model.

The whisper recognition based voice model may be configured to reflect a voice change associated with the whisper and a voice reverberation associated with the hand gesture.

In another general aspect, a user terminal may include a sensor unit configured to detect a hand gesture performed to express a whisper and a voice input associated with the whisper, and a processor configured to determine whether to activate a whisper recognition mode based on the hand gesture and the input voice.

The processor may be configured to determine whether to activate the whisper recognition mode by combining information on whether a touch is input on a screen of the user terminal by the hand gesture, a change in a light intensity generated based on the hand gesture, and a loudness change of the input voice.

The processor may be configured to determine whether to activate the whisper recognition mode by combining information on whether a touch is input within a preset area on a screen of the user terminal by the hand gesture, information on whether a change in a light intensity generated based on the hand gesture exceeds a preset light intensity threshold value, and information on whether a loudness change of the input voice exceeds a preset loudness threshold value.

In response to the processor determining to activate the whisper recognition mode, the processor may be configured to recognize words in the whisper using a whisper recognition based voice model.

In another general aspect, a non-transitory computer-readable storage medium comprising a program comprising instructions to cause a computer to perform the above described method is provided.

In yet another general aspect, a user terminal may include a first sensor configured to determine a whispering action by detecting a touch on a surface of the user terminal, a second sensor configured to detect a whisper by detecting a sound, and a whisper recognition activator configured to determine whether to activate a whisper recognition mode based on an input from the first sensor and the second sensor.

The first sensor may include a microphone, and the second sensor may include a touch sensor, a touch screen or a touch pad.

In general aspect of the user terminal may further include a voice recognizer configured to recognize words in a whisper received by the user terminal by using an acoustic model for whisper recognition stored in a non-transitory computer memory.

In general aspect of the user terminal may further include a voice recognition applier configured to determine whether a user command is present in the recognized whisper and to apply the user command in providing a service through the user terminal.

Other features and aspects will be apparent from the following detailed description, the drawings, and the claims.

### BRIEF DESCRIPTION OF THE DRAWINGS

FIG. 1 is a diagram illustrating an example of a user terminal.

FIGS. 2 and 3 are diagrams illustrating examples of methods of detecting a whisper to activate a whisper recognition mode.

FIG. 4 is a flowchart illustrating an example of a whisper recognizing method that includes transmitting a whisper received through a voice recognition sensor to a server, receiving an analysis result, and providing a service.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

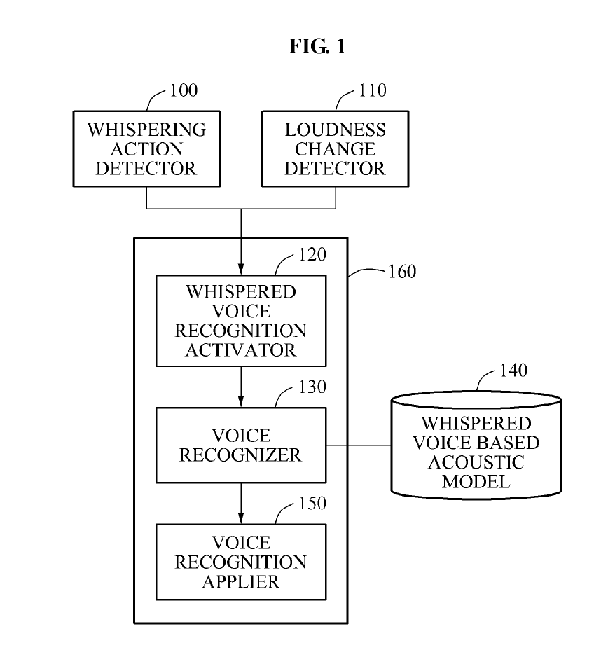

FIG. 1 is a diagram illustrating an example of a user terminal.

The user terminal described hereinafter is a terminal that may detect a status change through embedded sensors and may process the detected status change through a processor. The user terminal may be, for example, a smartphone, a portable terminal such as a personal digital assistant (PDA), a wearable device attachable to or detachable from a body of a user, a television (TV) or a vehicle including a voice command system.

The user terminal may detect a status change that is occurring around the user through its sensors. For example, the user terminal may operate embedded sensors that use a low amount of power while maintaining its main processor in an idle state. Thus, in the idle state, the user terminal may detect any status change that may be occurring around the user through the embedded sensors.

Referring to FIG. 1, the user terminal includes a whispering action detector 100 and a loudness change detector 110. The whispering action detector 100 and the loudness change detector 110 detect any status change that may be occurring around the user even when the user terminal is in the idle state.

A whispering action to be described hereinafter refers to one of many actions that indicate an intention of whispering. For example, the whispering action may include placing a face of the user close to the user terminal and covering the mouth of the user with a hand. The whispering action detector 100 detects such an action and recognizes the intention of the user to communicate something by whispering.

The whispering action detector 100 detects an action performed by the user through a first sensor to recognize a whispering action. The first sensor may include, for example, a touch sensor and a light intensity sensor.

In an example, the whispering action detector 100 recognizes the whispering action by detecting a touch input on a screen of the user terminal through the touch sensor.

In another example, the whispering action detector 100 recognizes the whispering action by detecting a change in a light intensity on the screen of the user terminal through the light intensity sensor. The whispering action detector 100 detects an action performed by the user using at least one of the touch sensor and the light intensity sensor to recognize the whispering action indicating the intention of the user to communicate by whispering to activate a whisper recognition mode.

A whisper recognition activator 120 determines whether to activate the whisper recognition mode based on a result of the recognizing by the whispering action detector 100 and the loudness change detector 110.

The whispering action detector 100 detects an occurrence of a touch on the screen of the user terminal through the touch sensor. For example, an ulnar side of a palm of the user may touch the screen of the user terminal so that the user may whisper to the user terminal without being heard by others in the surrounding. For another example, a face of the user may touch the screen of the user terminal so that the user may express a whisper. The whispering action detector 100 detects, in addition to an occurrence of a touch, a pressure intensity of the touch and a location at which the touch occurs. In addition, the whispering action detector 100 determines whether the pressure intensity of the touch exceeds a touch pressure threshold value or whether the touch is detected at a predetermined location. Thus, the whispering action detector 100 detects various whispering actions of the user that may occur on the screen of the user terminal. In one example, the touch pressure threshold value may be set by the user or by an operator of a service providing the whisper recognition mode.

The whispering action detector 100 detects a change in a light intensity of light entering the light intensity sensor. The whispering action detector 100 detects the change in the light intensity of the light entering the light intensity sensor when the user approaches, and determines whether the detected change in the light intensity exceeds a light intensity threshold value.

In an example, the loudness change detector 110 detects loudness, or an intensity of a voice to be input to a voice recognition sensor. The voice recognition sensor refers to a sensor that may recognize a voice of the user. For example, the voice recognition sensor may include a microphone. The loudness change detector 110 detects a loudness change of a voice input to the voice recognition sensor and determines whether the detected loudness change exceeds a loudness threshold value.

The whisper recognition activator 120 determines whether to activate the whisper recognition mode based on a result of detection performed by the whispering action detector 100 and the loudness change detector 110. The whisper recognition activator 120 activates the whisper recognition mode in response to the whisper recognition activator 120 recognizing the whispering action and the whisper of the user through the sensors.

Thus, the whisper recognition activator 120 activates the whisper recognition mode in response to the whispering action detector 100 recognizing the whispering action of the user and/or the loudness change detector 110 recognizing the whisper of the user.

In an example, the whisper recognition activator 120 activates the whisper recognition mode in response to the whispering action of the user being recognized based on a result of detecting an action of the user through the touch sensor, and the loudness change based on the whisper recognized through the voice recognition sensor exceeds the loudness threshold value.

In another example, the whisper recognition activator 120 activates the whisper recognition mode when the change in the light intensity associated with the action of the user and detected through the light intensity sensor exceeds the light intensity threshold value. The loudness change based on the whisper detected through the voice recognition sensor exceeds the loudness threshold value. However, a method of activating the whisper recognition mode may not be limited thereto, as various methods may be applied to the user terminal to recognize a whispering action and a whisper of the user so as to determine whether to activate the whisper recognition mode based on a result of the recognizing.

In an example, the whisper recognition activator 120 activates the whisper recognition mode in response to: a touch occurring by the ulnar side of the palm of the user, the change in the light intensity exceeding the preset light intensity threshold value, and/or the loudness change exceeding the preset loudness threshold value. In another example, the whisper recognition activator 120 activates the whisper recognition mode in response to the change in the light intensity exceeding the light intensity threshold value and the loudness change exceeding the loudness threshold value, despite an absence of a touch by the ulnar side of the palm. In still another example, the whisper recognition activator 120 activates the whisper recognition mode in response to the touch occurring by the ulnar side of the palm and the loudness change exceeding the loudness threshold value, despite the change in the light intensity being less than the light intensity threshold value.

A voice recognizer 130 recognizes a whisper of the user to be input using a whisper based acoustic model 140 dedicated to whispers. The acoustic model 140 refers to a model that may have been obtained by training based on sounds of whispered voices to improve accuracy in recognizing words contained in whispers. For example, features such as a sound or a voice, and reverberation may be different when the user is whispering and when the user is speaking in a usual voice or a usual speech. Thus, the acoustic model 140 may refer to a linguistic model that may be used to more accurately recognize a voice of the user based on the features indicated when the user expresses a whisper.

The acoustic model 140 may be stored in a non-transitory memory of the user terminal or a server disposed externally from the user terminal. When the acoustic model 140 is stored in an external server, the user terminal may transmit a received whisper of the user to the external server. The server may then analyze the whisper received from the user terminal using the acoustic model 140 and transmit a result of the analyzing to the user terminal.

The user terminal updates the acoustic model 140 based on a preset cycle or a request from the user. Thus, the user terminal may improve a whisper recognizing performance of the acoustic model 140 by constantly training the acoustic model 140 in the features of the whisper of the user in response to a receipt of the whisper of the user.

Also, the user terminal may store the acoustic model 140 in the memory, analyze the whisper input through the voice recognition sensor, and update the acoustic model 140 based on a result of the analyzing. Alternatively, the user terminal may transmit the whisper of the user to the external server. The server may then update the acoustic model 140 based on the result of the analyzing.

A voice recognition applier 150 executes a desired service to be executed through a whisper of the user based on a result of analysis performed by the server or a processor of the user terminal. In an example, the voice recognition applier 150 may execute all application services that use a voice recognition function, for example, a conversation engine, a voice command, transmission of a short message service (SMS) message, dictation, and real-time interpretation. In addition, the voice recognition applier 150 may execute a personal assistant service provided by, for example, a smartphone. Accordingly, the user terminal may maximize utilization of a voice recognition service even in a public place and improve accuracy in the voice recognition service through use of the acoustic model 140 dedicated to whisper recognition. In this example, the whisper recognition activator 120, voice recognizer 130 and voice recognition applier 150 may be implemented on one or more computer processor 160.

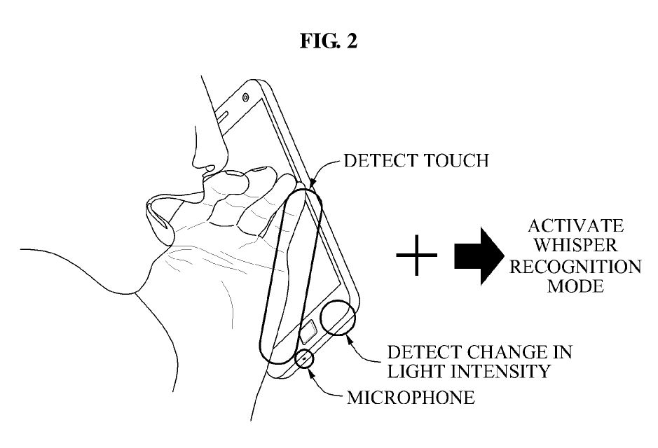

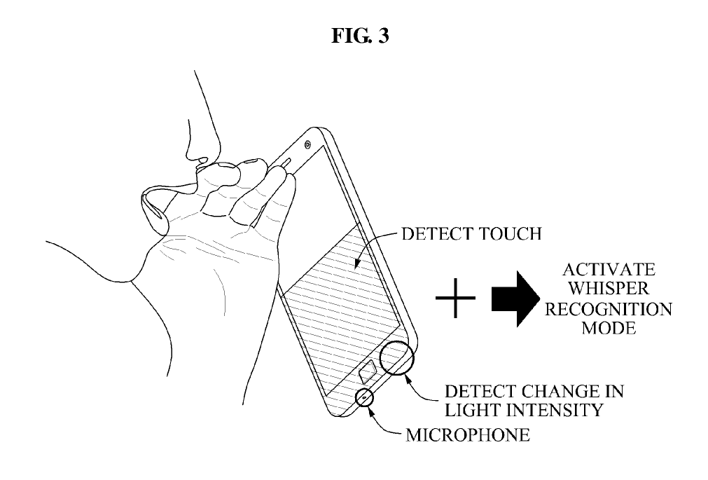

FIGS. 2 and 3 are diagrams illustrating examples of methods of detecting a whispering action to activate a whisper recognition mode.

A user terminal may detect a whispering action and/or a whisper of a user through sensors. For example, the user may whisper a command to the user terminal in a low voice by covering the user's mouth with his or her hand and placing the face close to the user terminal. This whispering action may convey to the user terminal that the user intends to whisper a user command or a message to the user terminal. The volume of the voice of the user received by the user terminal may also indicate that the user is whispering to the user terminal. In response to the user terminal recognizing the whispering action and the whisper through the sensors, the user terminal may determine whether to activate a whisper recognition mode.

The whispering action of the user may be detected through a touch sensor and a light intensity sensor. For example, the whispering action may be recognized based on at least one of an occurrence of a touch on a screen of the user terminal and a change in a light intensity of light entering the light intensity sensor in response to detection of a body of the user on the screen of the user terminal.

The whisper of the user may be recognized through a voice recognition sensor. For example, the whisper may be lower than a usual voice of the user. Thus, the user terminal may recognize whether the user expresses the whisper by detecting a loudness change through the voice recognition sensor.

The user terminal may detect the whispering action and the whisper of the user through the sensors, and determine whether to activate the whisper recognition mode based on a result of the detection.

Referring to FIG. 2, in an example, the user terminal detects a touch through the touch sensor at a moment when an ulnar side of a palm of the user touches the screen of the user terminal through which the user performs a whispering action. Accordingly, the user terminal determines that such an action may indicate an intention of whispering to the user terminal.

In another example, in response to a touch being detected within a preset range, the user terminal recognizes that the detected touch corresponds to a whispering action. As illustrated in FIG. 2, the user may touch an area around the voice recognition sensor on the screen of the user terminal to whisper to the user terminal. Accordingly, when the touch is input within the preset range from the voice recognition sensor, the user terminal may determine that the touch includes the intention of whispering. Referring to FIG. 3, when a touch is input in a shaded area, the user terminal may determine that the touch is being input to activate the whisper recognition mode. Conversely, in response to the ulnar side of the palm being detected out of the shaded area, the user terminal may determine that such an action does not indicate an intention to whisper to the user terminal.

In still another example, in response to the user terminal detecting a change in a light intensity through the light intensity sensor and the detected change in the light intensity exceeds a preset light intensity threshold value, the user terminal may determine that an action performed by the user indicates an intention of whispering to the user terminal.

An intensity or loudness of a voice input from the user to the user terminal may become lower. When a loudness of the input voice is changed more than a loudness of a usually input voice based on a loudness threshold value, the user terminal may recognize the input voice as a whisper.

When the whisper recognition mode is activated, the user terminal may recognize the whisper of the user using an acoustic model dedicated to whispered voices. For example, as illustrated in FIG. 2, when the user whispers to a microphone by covering a mouth with a hand, a reverberation of the whisper may be changed accordingly. Also, when the user speaks in a lower voice than usual, the voice to be recognized by the voice recognition sensor may be different from a usual voice. Thus, the user terminal may more accurately recognize a voice of the user using the acoustic model based on a feature indicated when the user performs a whispering action. The acoustic model dedicated to the whispered voices may be used for various products to which a voice recognition system is provided.

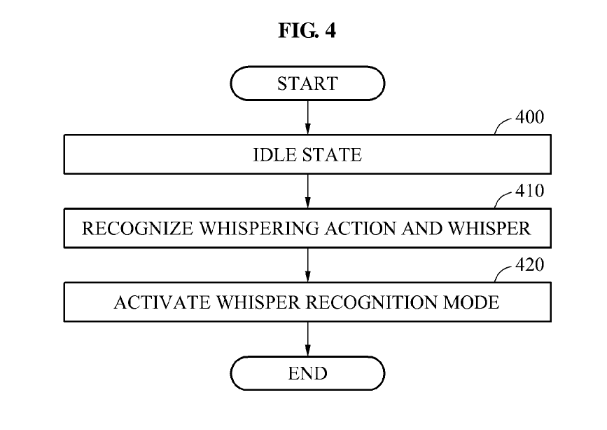

FIG. 4 is a flowchart illustrating an example of a whisper recognizing method that includes detecting a whispering action performed by a user and activating a whisper recognition mode.

Referring to FIG. 4, in 400, a user terminal detects a status change occurring around the user terminal through sensors. For example, the user terminal may operate embedded sensors using low power while maintaining a main processor to be in an idle state. Thus, although being in the idle state, the user terminal may detect the status change occurring around the user terminal using the embedded sensors.

In 410, the user terminal detects a whispering action performed by the user and a whisper expressed by the user. For example, when the user expresses a whisper, the user may cover a mouth with a hand and speak in a low voice. The user terminal may then detect such an action of covering the mouth with the hand and loudness through the sensors. The user terminal may detect the whispering action of covering the mouth through a touch sensor and a light intensity sensor, and the loudness through a voice recognition sensor. However, the whispering action may not be limited to the action of covering the mouth with the hand, but include all actions taken to express a whisper.

The user terminal detects whether a touch is input on a screen of the user terminal through the touch sensor. For example, the user terminal may detect, through the touch sensor, whether an ulnar side of a palm or a face of the user touches the screen of the user terminal.

Alternatively, the user terminal detects whether a touch is input within a present area on the screen of the user terminal. For example, when the user desires to whisper to the user terminal, a touch may be input by a body of the user within an area around a microphone of the user terminal. Thus, the user terminal may detect whether the touch is input within the area around the microphone.

Alternatively, the user terminal detects a pressure of a touch input by the body on the screen of the user terminal. For example, when the pressure of the touch exceeds a preset pressure threshold value, the user terminal may determine that an action performed by the user includes an intention of whispering.

The user terminal determines whether a change in a light intensity detected through the light intensity sensor by a hand gesture performed to whisper exceeds a preset light intensity threshold value.

The user terminal determines whether a loudness change of a voice to be input through the voice recognition sensor exceeds a preset loudness threshold value. In detail, the user terminal receives a voice of the user input through a microphone. The user terminal then compares the input voice to a usual voice of the user and determines that the input voice corresponds to a whisper in response to the loudness change exceeding the preset loudness threshold value.

In 420, the user terminal detects the action and the voice of the user through the sensors, and determines whether to activate the whisper recognition mode based on a result of the detection. When the user terminal determines that the action and the voice of the user include an intention of whispering, the user terminal determines whether to activate the whisper recognition mode. Concisely, in response to the user terminal recognizing a whispering action and a whisper through the sensors, the user terminal may activate the whisper recognition mode.

In an example, in response to the user terminal detecting an occurrence of a touch input by a body of the user, or a change in a light intensity exceeding the preset light intensity threshold value, the user terminal may recognize that an action performed by the user includes the intention of whispering. In addition, in response to a loudness change detected through the voice recognition sensor exceeding the preset loudness threshold value, the user terminal may recognize that a voice of the user corresponds to a whisper. Thus, in response to the user terminal recognizing the whispering action and the whispering sound, the user terminal may determine to activate the whisper recognition mode.

For example, the user terminal may activate the whisper recognition mode in response to: a touch being input by the body of the user, the change in the light intensity exceeding a present light intensity threshold value, the loudness change exceeding a preset loudness threshold value, or a combination thereof. In another example, in response to the change in the light intensity exceeding the preset light intensity threshold value and the loudness change exceeding the preset loudness threshold value, the user terminal may activate the whisper recognition mode, despite an absence of a touch input by the body of the user. In still another example, in response to a touch being input by an ulnar side of a palm of the user and the change in the light intensity exceeding the preset light intensity threshold value, the user terminal may activate the whisper recognition mode, despite the loudness change being less than the preset loudness threshold value. However, a method of activating the whisper recognition mode may not be limited to the foregoing examples; rather, the whisper recognition mode may be activated by detecting a whispering action and a whispering sound through various sensors.

When the whisper recognition mode is activated, the user terminal may more accurately recognize a whisper of the user using a whisper recognition based voice model. The whisper recognition based voice model to be described hereinafter may refer to the acoustic model dedicated to whispered voices described with reference to FIG. 1.

The user terminal reflects a voice changed depending on the whispering action of the user and a reverberation of the voice using the whisper recognition based voice model. Thus, the user terminal may more accurately recognize the words contained in the whisper of the user.

The whisper recognizing method may be used for various services. The services may include all application services using a voice recognition function. For example, the whisper recognition method may be used for all the application services using the voice recognition function, for example, a conversation engine, a voice command, transmission of an SMS message, dictation, and real-time interpretation. In addition, the whisper recognizing method may be used for a voice-based personal assistant service provided by, for example, a smartphone. For example, when the whisper recognition mode is activated and the user whispers to the user terminal, for example, “open English dictionary,” the user terminal may then accurately analyze the sound of the whisper of the user using the acoustic model dedicated to whispered voices and execute an English dictionary application based on a result of the analyzing.

The units described herein may be implemented using hardware components and software components. For example, the hardware components may include microphones, to amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of recognizing a whisper, the method comprising:
recognizing a whispering action performed by a user through a first sensor;
recognizing a loudness change through a second sensor; and
activating a whisper recognition mode based on the whispering action and the loudness change.

2. The method of claim 1, wherein the recognizing of the whispering action is performed based on any one of whether a touch is detected on a screen of a user terminal through a touch sensor, whether a touch pressure exceeds a pressure threshold value, and whether a touch is input within a preset area on the screen of the user terminal.

3. The method of claim 1, wherein the recognizing of the whispering action is performed based on whether a change in a light intensity detected through a light intensity sensor exceeds a preset light intensity threshold value.

4. The method of claim 1, wherein, in response to the whisper recognition mode being activated, the activating further comprises recognizing the whisper using a whisper recognition based voice model.

5. The method of claim 4, wherein the whisper recognition based voice model is configured to reflect a voice change associated with whispering and a voice reverberation associated with a hand gesture performed to whisper.

6. A method of recognizing a whisper, the method comprising:
detecting a hand gesture performed to whisper and a voice input associated with the whisper; and
determining whether to activate a whisper recognition mode based on the hand gesture and the input voice.

7. The method of claim 6, wherein the determining is performed by combining information on whether a touch is input on a screen of a user terminal by the hand gesture, a change in a light intensity generated based on the hand gesture, and a loudness change of the input voice.

8. The method of claim 6, wherein the determining is performed by combining information on whether a touch is input within a preset area on a screen of a user terminal by the hand gesture, information on whether a change in a light intensity generated based on the hand gesture exceeds a preset light intensity threshold value, and information on whether a loudness change of the input voice exceeds a preset loudness threshold value.

9. The method of claim 6, wherein, in response to the activating being determined, the determining further comprises recognizing words contained in the whisper using a whisper recognition based voice model.

10. The method of claim 9, wherein the whisper recognition based voice model is configured to reflect a voice change associated with the whisper and a voice reverberation associated with the hand gesture.

11. A user terminal, comprising:
a sensor unit configured to detect a hand gesture performed to express a whisper and a voice input associated with the whisper; and
a processor configured to determine whether to activate a whisper recognition mode based on the hand gesture and the input voice.

12. The user terminal of claim 11, wherein the processor is configured to determine whether to activate the whisper recognition mode by combining information on whether a touch is input on a screen of the user terminal by the hand gesture, a change in a light intensity generated based on the hand gesture, and a loudness change of the input voice.

13. The user terminal of claim 11, wherein the processor is configured to determine whether to activate the whisper recognition mode by combining information on whether a touch is input within a preset area on a screen of the user terminal by the hand gesture, information on whether a change in a light intensity generated based on the hand gesture exceeds a preset light intensity threshold value, and information on whether a loudness change of the input voice exceeds a preset loudness threshold value.

14. The user terminal of claim 11, wherein, in response to the processor determining to activate the whisper recognition mode, the processor is configured to recognize words in the whisper using a whisper recognition based voice model.

15. A non-transitory computer-readable storage medium comprising a program comprising instructions to cause a computer to perform the method of claim 1.
